(19) United States
(12) Patent Application Publication
(10) Pub. No.: US 2016/0264442 A1
(43) Pub. Date: Sep. 15, 2016

(54) NUTRIENT CONCENTRATION AND WATER RECOVERY SYSTEM AND ASSOCIATED METHODS

(71) Applicant: Renewable Energy Alternatives, LLC, Brush Prairie, WA (US)

(72) Inventor: Robert KNOOP, Brush Prairie, WA (US)

(21) Appl. No.: 14/952,305

(22) Filed: Nov. 25, 2015

Related U.S. Application Data
(60) Provisional application No. 62/084,325, filed on Nov. 25, 2014.

(51) Int. Cl. C02F 9/00; B01D 21/24; B01D 21/00; B01D 21/01; C02F 1/52; C02F 1/24

(52) U.S. Cl. CPC C02F 9/00; C02F 1/52; C02F 1/24; B01D 21/0084; B01D 21/01; B01D 21/245; C02F 1/441

(57) ABSTRACT

A nutrient concentration and water recovery system includes an initial waste water dewatering tank configured to receive waste water and producing a waste stream. A suspended solid settling tank includes an integral lamella clarifier configured to produce a discharge to a surge tank or repurposed.

### CROSS-REFERENCE TO RELATED APPLICATION

The present application claims priority to U.S. Provisional Patent Application No. 62/084,325, filed Nov. 25, 2014, the contents of which are incorporated by reference as forth herein.

### FIELD OF THE INVENTION

The present invention is directed generally to nutrient concentration and water recovery systems and associated methods, and more particularly to removing all available nutrients and suspended organic matter thereby generating a much cleaner water component.

### BRIEF DESCRIPTION OF THE RELATED ART

The use of chemicals and/or replacement filters is both labor intensive and costly when compared to the Nutrient Concentration and Water Recovery system. In addition to avoiding the odorous off gassing from lagoons, the Nutrient Concentration and Water Recovery system generates distinctive low (volumetric) flow rejects streams. Each reject stream has specific total suspended solids (TSS) and total dissolved solids (TDS) characteristics.

When treating organic waste in order to feed an anaerobic digester, there is a need to maximize the waste material consistency in order to maximize the amount of volatile organic matter that can be processed in higher concentration digesters. As the processing time can involve many days, the capital cost of the digester equipment can be very high, unless the concentration of the organics can be increased. Unfortunately, the higher the concentration, the greater is the difficulty in pumping (transferring) the organic sludge between unit process steps. Consequently, normal high consistency feed levels as currently practiced are limited to 5 to 9% consistency. Lagoons are used for aerobic digestion of organic material. In many cases, CAFOs or concentrated animal feed operations such as dairies, hog and swine operations or in other cases food processing plant waste streams utilize lagoons to process the organic material within their waste streams. This list of applications/industries is intended to be representative and not complete.

Lagoons are land intensive. They also have the potential during rainy seasons to spill over and contaminate local watersheds/water streams. In addition, the potential for noxious odors is very high. Although there is potential in the summer time to concentrate the nutrients by way of evaporation, aerobic lagoons also discharge nitrogen gas as well as methane to the atmosphere. The nitrogen would be better used to fertilize, while the methane gas is one of the more problematic greenhouse gas contributors. In fact methane gas is 23 to 24 times more injurious to the atmosphere than carbon dioxide.

When the lagoon material is finally ready to be land applied, more than 180 to 250 days of storage within the lagoon has elapsed. The residual phosphorus and potassium within the liquid fraction in the lagoon are applied in a “as is condition” which can in turn overload the fertilized fields with some nutrients. Levels as defined by the Nutrient Land Management Act are often exceeded. Phosphorous, given the slow release and pickup by the crops is usually the limiting nutrient.

All lagoon installations require ongoing maintenance.

### BRIEF DESCRIPTION OF DRAWINGS

FIG. 1 is a flow chart illustrating interconnections between sequential unit process in one embodiment of the present invention.

FIG. 2 is a flow chart that illustrates use of a chemical metering process unit that can be utilized in one embodiment of the present invention for injecting chemicals into a primary flow stream.

FIG. 3 illustrates one embodiment of a unit process equipment that can utilized with the present invention, more particularly to confirm the capability of certain automatic back washable filter units.

FIG. 4 illustrates one embodiment of a fractionation tank that includes a lamella clarifier in one embodiment of the present invention.

FIG. 5 illustrates a DAF unit process step used in one embodiment of the present invention.

FIG. 6 illustrates a plurality of reverse osmosis (RO) elements that can be utilized in one embodiment of the present invention.

FIG. 7 illustrates a two stage reverse osmosis skid in one embodiment of the present invention.

FIG. 8 illustrates a flow diagram of a dairy field test carried in one embodiment of the present invention.

FIG. 9 illustrates one embodiment of a typical particle sized material that can be removed in one embodiment of the present invention.

FIG. 10 illustrates a vibrating screen element that can be used in one embodiment of the present invention.

FIG. 11 illustrates a bag and cartridge filter assembly that can utilize in one embodiment of the present invention.

FIG. 12 illustrates a centrifugal separator that can be used in one embodiment of the present invention.

FIG. 13 illustrates a storage tank that can be used in one embodiment of the present invention.

### SUMMARY

An object of the present invention is to provide systems and methods that remove particulates from waste streams.

Another object of the present invention is to provide systems and methods that remove particulates from waste streams and reduce maintenance of lagoons.

Yet another object of the present invention is to provide systems and methods that remove particulates from waste streams to reduce maintenance of lagoons at selected locations.

A further object of the present invention is to provide systems and methods that remove particulates from waste streams and increase recovery of nutrients from waste streams.

Another object of the present invention is to provide systems and methods that remove particulates from waste streams and increase an amount of clean water for re-use.

Another object of the present invention is to provide systems and methods that remove particulates from waste streams and increase an amount of clean water for re-use that is low cost with reduced operator intervention.

Another object of the present invention is to reduce the particulate in the waste stream going to the lagoon(s) in the form of suspended solids (TSS) as organic matter and therefore reduce the aerobic action within the lagoon(s) thereby reducing the methane gas (biogas) released to the atmosphere because of the aerobic process.

Another object of the present invention is to reduce the loss of nitrogen within the waste stream which would naturally off gas if stored in an uncovered lagoon.

Another object of the present invention is to concentrate the nitrogen rich sludge and waste material removed from the waste stream and store in closed tanks in order to minimize nitrogen off gassing to the atmosphere.

Another object of the present invention is to provide a mobile Nutrient and Water Recovery system to perform the same objectives at seasonal lagoons, abandoned lagoons, or provide bypass capacity around existing systems to permit scheduled and unscheduled maintenance. These and other objects of the present invention are achieved in, a nutrient concentration and water recovery system. An initial waste water dewatering tank is configured to receive waste water and producing a waste stream. A suspended solids settling tank includes an integral lamella clarifier configured to produce a discharge to a surge tank or repurposed.

### DETAILED DESCRIPTION

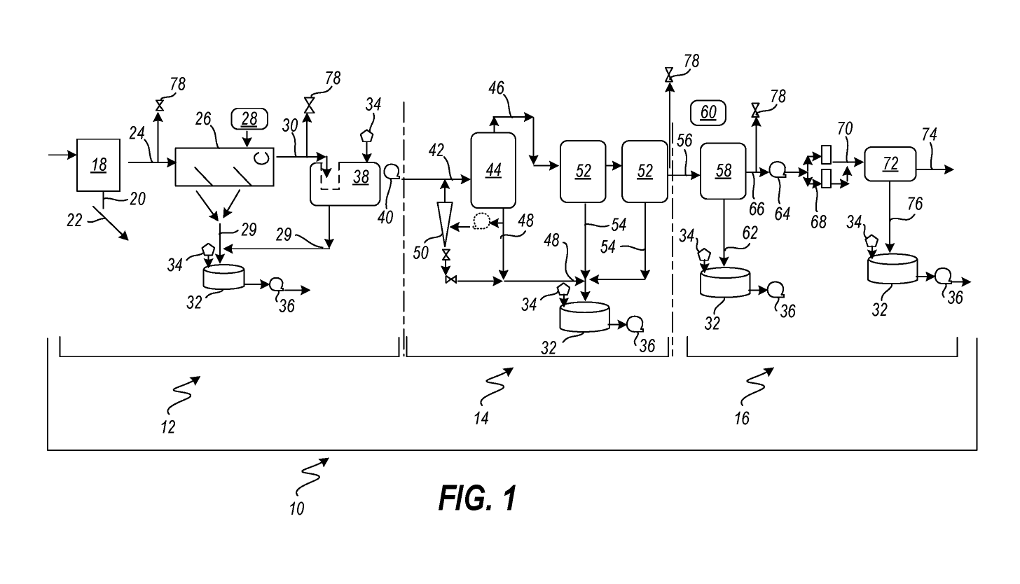

In one embodiment a nutrient concentration and water recovery system 10 (hereafter system 10) FIG. 1, and associated methods of its use are provided. As a non-limiting example, by removing the clean water component from the waste stream with this process technology, the original volatile organics in both the suspended solids and the dissolved solids state(s) can be retained and concentrated. In one embodiment the volatile organics level can be maximized. In one embodiment the present invention allows increasing the final targeted digester feed consistency (if required) without loss of the volatile organics.

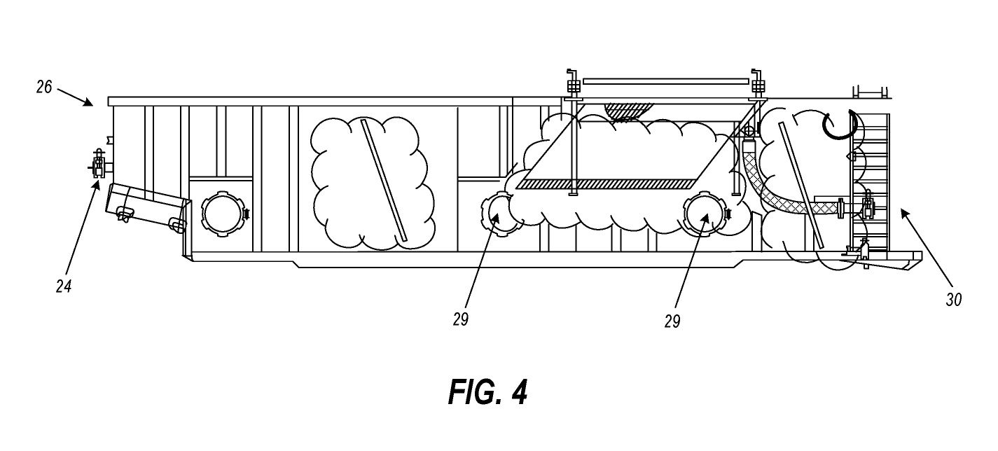

In one embodiment system 10, illustrated in FIG. 1 includes 3 stages and a number of unit processes within each stage. Stage 1 Detailed as Subsystem 12 on FIG. 1 includes the initial wastewater dewatering equipment 18 as well as a combination (Reference FIG. 4.) suspended solids settling tank and integral lamella clarifier 26 with discharge to either a surge tank or repurposed and designated lagoon 38. Incorporated into this system Subsystem 12 is a chemical metering skid 28 in order to enhance the suspended solids removal performance of the lamella type clarifier and a sludge tank 32 with appropriate controls 34 and sludge handling system pump 36. There is also located after surge tank 38, a transfer pump 40 which pressurizes the accumulated intermittent flow volume and transfers downstream to 2^{nd} stage detailed as Subsystem 14 on FIG. 1.

This 1st stage of the overall nutrient concentration and water recovery system 10 is sized to handle peak flows as in the case of the intermittent barn flush activity. By non-limiting example, a 3000 head dairy if barn flushed 3 times per day can generate between 200,000 to 300,000 gallons of wastewater. Therefore during the periods between barn flush activities, if the large and somewhat instantaneous flows can be contained, the downstream equipment can be downsized to take advantage of the overall time duration between barn flushes. There are large capital cost savings associated with reducing the size of the continuous downstream processing equipment. By non-limiting example, the situation above would result in continuous flow rates in the subsequent downstream stages 2 and 3, identified on FIG. 1 as Subsystem 14 and Subsystem 16 of 130 gallons per minute to 210 gallons per minute. In addition, the suspended solids removal equipment 26 located after the vibrating screen or equivalent unit process 18 is necessary to remove a substantial fraction of the suspended solids entering system 10. By removing between 40 to 90% of the TSS within incoming water at this point in the process maintenance associated with cleaning out either the surge tank 38 or dedicated on-site lagoon is reduced. In addition, with a large portion of the settle able solids removed at this point in the process, the waste water quality would be improved allowing for greater recycling of this water for barn flush, more nutrient material extract to be used on site as a fertilized substitute and reduced biogas (methane) off gassing at the waste water storage lagoon.

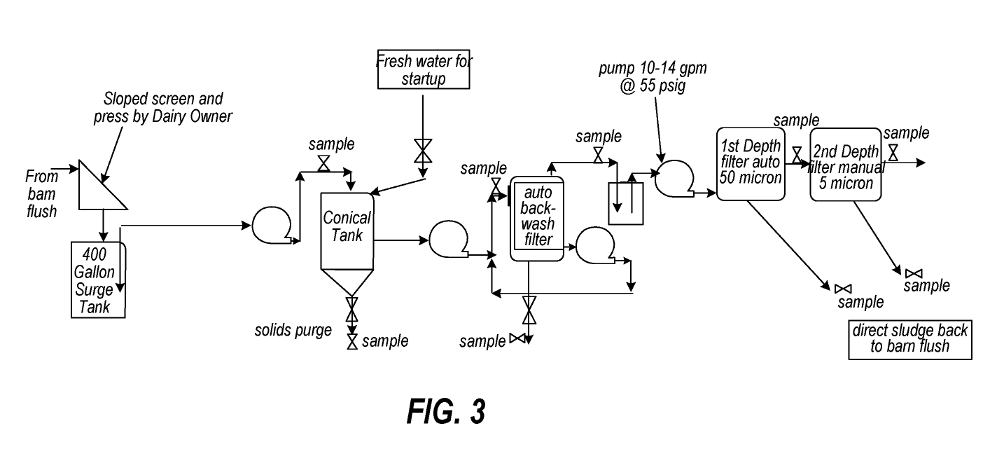

Detailed as Subsystem 14 on FIG. 1 represents the 2nd stage of the wastewater treatment system. Subsystem 14 includes a series of sequential automatic depth filters. Units can be equipped with progressively finer micron rated filters. Unit process 44 has an internal recirculating loop required to maintain filtration efficiencies. By cleaning the recirculated flow with centrifugal separator 50 or equivalent, recirculated organic TSS material can be continually bled away from the system thereby reducing the amount of TSS material subject to fiber breakdown due to traveling through the recirculating pump. This ensures that suspended material is removed rather than reduced in size and therefore transferred downstream to be removed by finer micron rated depth filtration. As in the 1^{st} stage, there is a common sludge removal system including a sludge tank 32 with level controls 34 and the sludge discharge pump 36. Subsystem 14 is sized for a much reduced continuous flow when compared to Subsystem 12 which was discussed above. As final depth filtration which include units 52 are rated down to 5μ with actual particulate removal ranging from 5 to 2μ, any residual TSS does not pose a settling problem in any of the on-site lagoon(s) or other storage tank. Reject streams 54 and 48 due to their similar characteristics are by non-limiting example co-mingled in the sludge tank 32. Reference FIG. 3. In addition to the laboratory analysis, an industry standard jar type test was performed on the water quality exiting the pilot test equipment represented by FIG. 3. After an overnight settling period, there was no evidence of either suspended solids or settled solids in the jar test. Based on these results, the lab results and the absolute filtration rating of units 52, very limited settling is anticipated in any of the lagoons on-site. This in turn minimizes lagoon maintenance, the potential for final lagoon liner damage associated with use of heavy sludge removal equipment, as well as minimal off gassing due to minimal TSS loading and minimal organic material.

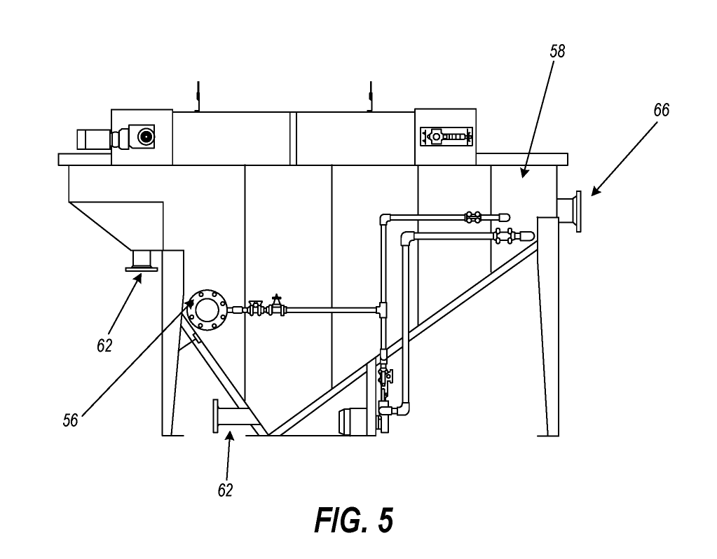

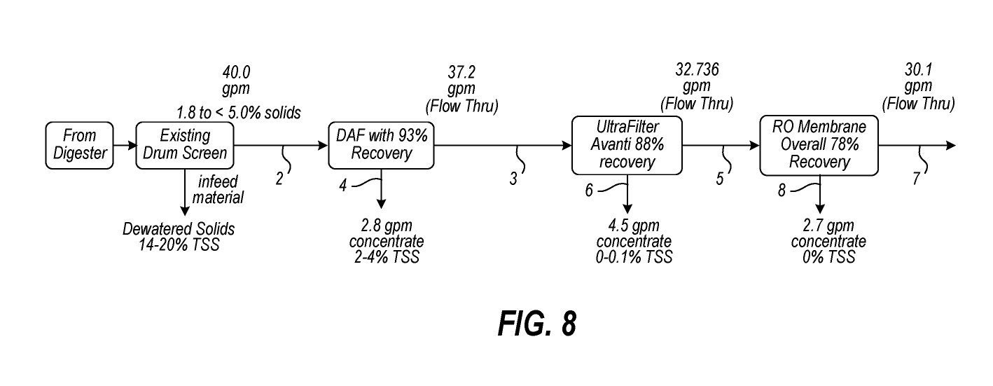

Subsystem 16 as shown in FIG. 1 is the final stage of filtration, nutrient removal and water recovery in system 10. The components within this Subsystem 16 incorporate many of the pilot test components used during the on dairy farm testing in 2012-2013, FIG. 8. Again as in the case of Subsystem 14 FIG. 1, the hydraulic loading for this system based on a non-limiting case of a 3000 head dairy herd would be between 130 gallons a minute to 210 gallons a minute. Based upon minimal TSS loading after the 5μ depth filter rated units 52, a dissolved aeration floatation (see FIG. 5) unit 58 complete with flocculating chemical addition by chemical metering skid 60, would reduce TSS loading in the accept stream 66 such that the final in-line cartridge filters 68 could remove any residual suspended solids. Sludge removed from the feed stream 56 as shown in reject stream 62 would be collected in sludge tank 32 with level in the tank controlled by level control 34 which would activate sludge discharge pump 36. The water quality as per flow stream 70 FIG. 1, would be suitable as reverse osmosis (RO) feed water.

The reverse osmosis unit is included in system 10 if the final water quality leaving the system needs to be at a water quality level not restricted any EPA criteria. It is expected that this water subject to further testing will be equivalent to non-potable water. The incremental benefits of the reverse osmosis system are the removal of any elevated chlorides within flow stream 70 as well as any elevated phosphorus levels. Note phosphorus used hereafter is intended to refer to the phosphorus compounds associated with its use as a key fertilizer element. Excess salts in irrigation water can lead to damaged croplands and phosphorous due to its very stable nature and slow pickup by crops is usually the nutrient that exceeds Nutrient Land Management Act levels. Because of the cost of reverse osmosis 72, a smaller reverse osmosis system not sized for the full process flow 70 may be installed. This is possible because the chloride and phosphorous levels are so reduced going through the reverse osmosis that a blended strategy with water not treated by the reverse osmosis system can be utilized and therefore the capital cost of the overall nutrient concentration and water recovery system 10 can be reduced. On a weighted average basis, if the reverse osmosis removes between 92 to 96% of the dissolved phosphorus and 92 to 98% of the sodium, a blend of 50% reverse osmosis treated water and 50% untreated would drop the dissolved concentrations in half. This may be based on local conditions be may allow unrestricted application to local fields for irrigation.

The detailed components incorporated into the overall process are made up from key process steps illustrated in FIGS. 3 and 8, which represent on dairy farm tests as non-limiting examples. These tests were required to validate the performance of these selected pieces of equipment when applied to this unconventional application.

In one embodiment cleaned water, illustrated in FIG. 1, flow stream 74 is recovered from the wastewater by system 10 and it approaches water quality standards associated with non-potable water quality, and therefore does not trigger contaminated water discharge restrictions. Reference FIG. 8 Reverse Osmosis product water stream 7. As a non-limiting example final cleaned water flow as indicated by 74 on FIG. 1 can be ⅝ to ⅞ of the original waste stream flow 24 FIG. 1. There are multiple reject streams coming out of system 10. If the use of a chemical metering system 28 is used to enhance the lamella clarifier suspended solids removal of unit 26, the concentration of the suspended solids in reject stream 29 can be increased by 5 to 40%. Solids concentration in this reject stream can be between 1 to 6% solids by weight. In system Subsystem 14, the sequential air assisted depth filters shown as 44 and 52 on FIG. 1 utilize compressed air to assist and minimize the use of water when required to backwash. Backwash is triggered by an accumulation of suspended solids on the surface of these depth filters which in turn exceeds a predefined cross filter surface pressure differential value, typically set from 5 to 10 PS IG. Use of compressed air with pressurized water reduces the dilution of the suspended solids in reject streams 29, 48 and 54. Solids concentrations in these reject streams can be between 1 to 6% by weight. Use of chemical metering skid 60 FIG. 1 to enhance the performance of the dissolved aeration flotation (see FIG. 5) unit 58 and therefore increase the concentration in reject stream 62 will again concentrate rejects. By increasing the solids concentration in these reject streams, the amount of material required to be handled is reduced, and the disposal or reuse options are expanded. With higher solids concentrations some of these reject streams can be added back to the dewatered suspended solids in flow stream 20 from vibrating screen 18 on FIG. 1.

In one embodiment these recovery ratios are achieved while applying normal recovery rates to each of the unit process steps employed during those field tests as more fully illustrated in FIG. 8. A recovery rate is defined as the percentage of final product (good cleaned) water generated as compared to the amount of water fed into that unit process step. In one embodiment unit process RO Membranes are used. As a non-limiting example, and as illustrated in FIG. 8, a 30 gallon per minute discharge of clean water is achieved when processing 40 gallons per minute of raw waste. As has been stated earlier, Subsystem 12 can be installed without Subsystem 14 and Subsystem 16 reference FIG. 1. If Subsystem 12 and Subsystem 14 are installed such that the reverse osmosis associated with Subsystem 16 is excluded, the overall recovery of these 1st two sub systems will be greater. It is anticipated based on pilot test data, that the combined subsystem recovery rates will be closer to 80 to 90%. It should also be noted, that the reject streams associated with the sub systems are high value added nutrient concentration streams that may in fact be worth more to the agricultural industry than the recovered clean water. By non-limiting example, the removal of contaminants from industrial wastewater flows may translate into significant reductions in existing wastewater penalties associated with excess TSS and BOD levels.

In one embodiment the overall nutrient concentration and water recovery system has expanded to include unit process steps illustrated in FIG. 3 and those from FIG. 8. The surge tank 38 FIG. 1 may be substituted for by cleaning and designating an existing lagoon to serve the purpose of storing the high intermittent flow volumes discussed earlier. Depending on water analysis required to fully analyze waste water flow 24 on FIG. 1, one less stage of depth filtration designated as 52 may be required while still delivering the water quality in flow stream 56. Unit processes 18, 26, 44 and 52 are required to deliver discharge water quality with less than 5μ particulate size and low concentrations of suspended solids ranging from 500 to 3800 mg/L. at flow stream 56. If very fine suspended solids without potential for accumulation in storage lagoons is adequate or the final extraction of fertilizer nutrients is not required, them units 58, 68 and 72 will not be required.

In one embodiment system 10, units 44, 52 and 68 are available as standard capacity units. At the flow rates required by example in a barn flush installation, multiple units are installed in parallel and piped in a manifold configuration to handle the capacity. Often one addition unit is installed to provide partial backup or redundant operation and reduced process failure vulnerability. Units 44 are available in three standard flow ranges of 5-20 gpm, 20-100 gpm and 100 to 300 gpm. Flow ranges will be impacted by the TSS loading of the waste stream 42. Units 52 have flow ranges from 5 to 25 gpm subject to the TSS loading of flow stream 46 as well as the micron ratings of the inserted filter media. System 10 can be added to existing front end dewatering device such as unit 18 if already installed and operational at site. it is assumed that in the case of an operating dairy, by non-limiting example, the farmer is already extracting the larger and heavier particulate from the waste stream with his existing dewatering device, prior to directing the liquid stream to this lagoon for storage or sequential series of lagoons for additional suspended solids settling in the 1^{st} or 2^{nd} of the sequential lagoons.

As units 44 and 52 are installed in multiples, the foot print can be managed to suite the location. The footprint can be a square or a rectangle and the footprint can be reduced by stacking units vertically. Any stacked height over 4 feet, would reduce access to upper units. A 20 foot by 20 foot square up to a 20 foot by 40 foot would be required for the flow range stated above. This modular approach to installing adequate flow capacity, permits dedicating individual systems to specific waste streams and enables improved performance with fine tuning, higher nutrient recovery rates, further segregation of nutrients for different end purposes and potentially higher byproduct value, and the like. System 10 as depicted in FIG. 1 can be sized for either very large or quite small flow streams. In addition, by non-limiting example, system 10 as installed at an industrial site may or may not have surge flow retention capability. Element 38 may not be present, and Subsystem 12 may not be sized for the large intermittent flows that typically occur on a dairy farm during barn flush activities. Therefore it is possible to size the system 10 for specific waste streams. In addition, the number of sequential subsystems from Subsystem 12 through Subsystem 14 and Subsystem 16 that are installed will be dictated based on the final water quality required in flow stream 74 of FIG. 1. By example, and industrial wastewater discharge may be trying to reduce BOD5 and TSS levels discharged to local municipal sewer districts. Subsystem 16 may not be required. From a practical standpoint, TSS levels may need to be less than 300 to 400 part per million (ppm) (or 300 to 400 mg/L) for compliance, instead of the 0 to 1 ppm exiting Subsystem 16.

In one embodiment system 10 supports an environmentally-friendly treatment of agricultural, industrial and food processing waste streams in order to remove the suspended and dissolved organic material. This creates concentrated N, P; K (nitrogen, phosphorous, potassium) based fertilizers and also cleans up the waste stream.

In one embodiment a final water discharged in flow stream 74 on FIG. 1 has little or no organic matter than can be aerobically consumed in the lagoons. As the multiple filtration steps through Subsystem 12, Subsystem 14 and Subsystem 16 are able to extract the suspended solids and dissolved solids from the wastewater stream, the residual amount of suspended solids left is very slight. Depending on which sub systems have been used, the total suspended solids concentration entering system 10 ranges from 15,000 to 30,000 mg/L and exits system 10 with virtually a nondetectable level of suspended solids. There is a very high correlation between suspended solids and the organic matter necessary to fuel the aerobic process in the lagoons. By non-limiting example, FIG. 8 shows a 17,000 mg/L pilot test system infeed and a 1 mg/L TSS level leaving the pilot test system As a result methane off gassing is radically reduced.

In one embodiment system 10 includes a reverse osmosis unit on this waste stream that can reject chlorides. By embedding inside of the reverse osmosis unit 72 an additional reverse osmosis process unit on the reject stream 76, sized for a much smaller flow rate with a very specific thin film membrane gram molecular cutoff for more exact molecular separation, the chlorides, sodium and the phosphorus nutrient can be separated out and chemically processed. In one embodiment phosphorus nutrient that is recovered can be a valuable fertilizer substitute. Phosphorus becomes problematic when it is applied in a “as is” condition along with the other concentrated nutrient streams. By separating it, the phosphorus can be added back in quantities such that the Nutrient Land Management Act acceptable levels are not exceeded System 10 can be utilized for a number of different applications, including but not limited to the following:

From Subsystem 12 FIG. 1, vibrating screen 18 or equivalent dewatering device will yield dewatered solids between 12 to 20%. Within incremental screw press on dewatered stream 20, solids levels between 20 to 35% can be achieved. This material can be sent to a composter for processing to generate fertilizer, or directly land applied based on seasonal requirements either on site or transported off-site. The dry matter can also be used as recycled bedding for the dairy herd. The rejects sludge from unit process 26 is discharged at between 1 to 6% solids. This sludge in flow stream 29 can be blended with the dewatered stream 20 for subsequent composting, recycled and directed to the front end of an anaerobic digester, or combined with other sludge streams to create a concentrated nutrient stream to be used as a fertilizer alternative. Within Subsystem 14 FIG. 1, all of the sludge streams from unit process 44 and 52 can be co-mingled, given their suspended solids content ranges from 1% to 6%. This material can be blended with the dewatered solids stream 20 and forwarded to a composter. The material could also be recycled to the front end of an anaerobic digester or combined with other sludge streams to create a concentrated nutrient stream to be used as a fertilizer alternative.

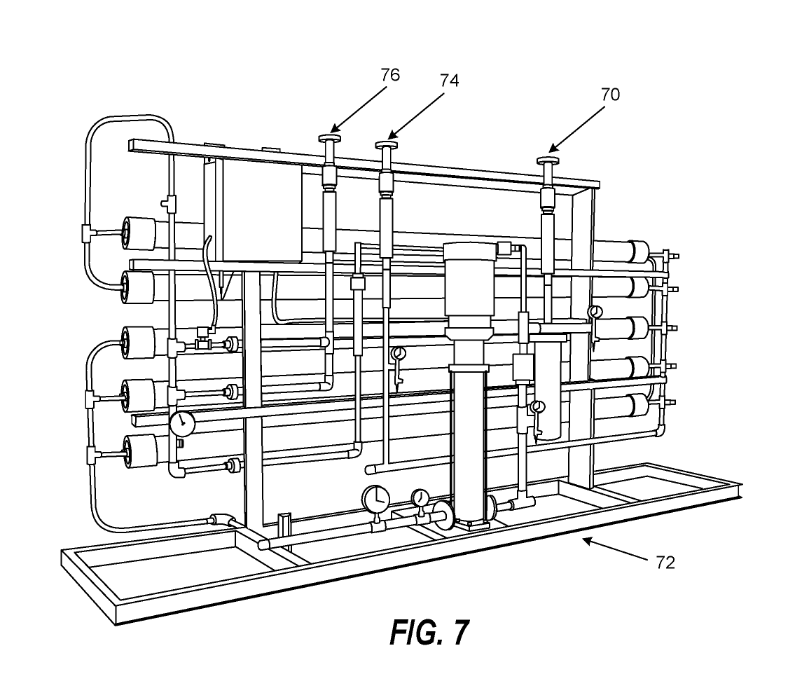

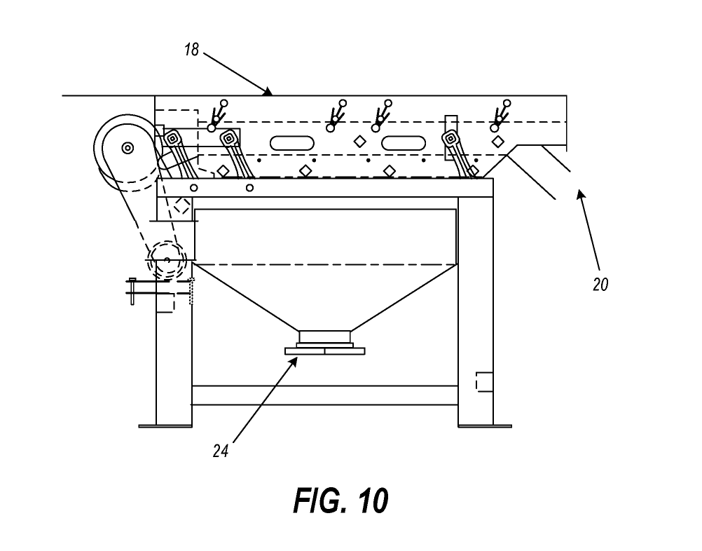

From Subsystem 16 FIG. 1, the rejects stream 62 from unit process 58 will have a solids concentration of between 0.3 to 2.5%. This volume of suspended solids can be recycled to the front end of an anaerobic digester or combined with other sludge streams as a concentrated nutrient. The reject stream 76 from the reverse osmosis unit 72 is a liquid stream. FIG. 8 indicates that the concentrate out of the reverse osmosis membrane system (see FIG. 7) as stream 8 has potassium, ammonia and phosphorus which are a minimum of 20 times more concentrated than the nutrients in the product water leaving the reverse osmosis skid (see FIG. 7) within stream 7. With the chloride concentrations reduced as per the strategy described above with an additional reverse osmosis rejects stream skid installed on rejects flow 76 in FIG. 1, the nutrients can be applied as a fertilizer substitute. The nutrients in reject stream 76 can be blended with other reject streams to increase the overall nutrient content and marketed locally or used on farm. The vibrating screen shown as the 1^{st} element 18 of System 10 is well-suited for a barn flush application on a dairy farm. Also see FIG. 10. Even though the dairy farm may be a concentrated animal feed operation (CAFO), with concrete as the primary surface upon which the dairy cattle walk, airborne sand and other inorganic material, as well as other organic materials within the animal feed accumulate and are present in the pumped barn flush water. As the vibrating screen does not use a compression zone to dewater like the Rotary drum screen press, the sand entrained in the waste liquid stream pumped by the farmer from the barn will do less erosion-based damage to the equipment. In addition the vibrating action of the screen moves the dewatered fiber to the end of the screen and avoids blinding over. Water analysis of the waste stream will indicate whether an 80 mesh (185 micron) opening will be the best choice. Screens with mesh ratings down to 200 (75 g) are available but the limited open area of the screen makes the required screen surface very difficult to maintain. The best screen selection is a compromise between finer mesh ratings and the tendency of the screen to blind over and become plugged. Experience with 80 mesh vibrating screens on dairy manure has been successful to date In one embodiment If the feed source to system 10 of The Nutrient Concentration and Water Recovery Equipment FIG. 1 is from an upstream digester, the long retention time and the slow horizontal velocity component within the digester process settles out the inorganic sand. If the erosive sand has been removed up stream, and the anaerobic digestion process has removed 40 to 60% of the organically based suspended solids, a Rotary drum screen press would be a better element 18 alternative.

In one embodiment the screw press, or rotary drum screen presses can be utilized. In order to minimize the use of additional powered material transfer equipment, a Rotary drum screen press would be installed in an elevated configuration like the vibratory screen such that the dewatered product in flow stream 20 can gravity fall onto pivot conveyor 22 for delivery to storage pile accumulation. The waste liquid stream is pumped into the internal opening of the Rotary screen. The perforated screen is on an incline and the liquid dewaters through the perforated walls while the remaining sludge is move diagonally upwards by internal flytes within the screen section. As the sludge drains, it also travels upward to the end of the screen by way of the flytes and then discharges into the nip where two additional perforated drums come together and rotate in opposite directions. The sludge is drawn into the nip where the 2 counter rotating drums are within the fractions of an inch of each other. The sludge is pressed between the 2 rolls, and the liquid is pushed through the perforations of the drums, while the dewatered solids are discharged on the other side of the nip onto pivot conveyor such as shown on system 10 element 22.

In one embodiment system 10 requires little to no chemical addition. The chemical addition rate associated with metering flocculating agent into flow stream 56 of FIG. 1 can range from less than 0.01 mg/L to over 1 mg/L. The chemical added is FDA approved. The final water quality is similar to non-potable water (higher quality to be subject to further laboratory verification) if cleaned and processed within Subsystem 16. FIG. 8 details the test trial results carried out in 2012-2013. As was stated earlier, when comparing the nutrient concentration of the reverse osmosis product water stream 7 to that of the reverse osmosis (see FIG. 7) reject water stream 8, the smallest concentrating factor achieved based on comparing the chemistry of both streams is greater than 20 times. This reject stream is in liquid form and as such can be transferred limited distances. This fertilizer material can be used in a number of applications. The dewatered solids in stream 20 from the vibrating conveyor and/or equivalent shown as element 18 on FIG. 1 can absorb some of the medium consistency rejects from flow stream 29, 48, 54 and 62. As discussed previously, concentrations of these reject streams are higher based on enhancing the suspended solids extraction of the depth filtration and clarifier and/or dissolved aeration flotation equipment (see FIG. 5). As long as the percent solids of the dewatered material leaving in waste stream 20 remains above 15% to 17%, the material can be trucked away, or fed to an on-site composter for subsequent bagging and/or further drying through a screw press prior to bagging as a wholesale soil amender or fertilizer. Targets would include nurseries, large box stores, landscaping companies, as well as municipal landscaping maintenance operations. If the material achieves class a bio solids status by being at sufficient temperature for sufficient duration within the composter, the soil amender/fertilizer could be used for organic farming.

In one embodiment system 10 enables the original volatile organics in either the suspended solids or dissolved solids state, that have been extracted from the waste flow, to be retained and concentrated such that the volatile organics level can then combined with the reject flow stream 76 discharged from the reverse osmosis (see FIG. 7) unit 72 of system 10 as per FIG. 1. The high levels of suspended solids extracted by the many sludge settling, filtration, and clarification and/or dissolved aeration flotation (see FIG. 5) technologies within system 10 are confirmed based on the percent total solids of these reject sludge streams depicted on FIG. 1. Given the organic nature of the dairy waste or of the industrial food processing waste facility, the high-level of suspended solids also has a very high organic component. Volatile suspended solids represent the organic loading in the stream flow. It is also a laboratory test to measure the same organic loading of the flow stream. When looking at FIG. 8 which depicted the field test in 2012-2013 at a dairy and comparing the high suspended solids levels (TSS) rejected from the DAF, flow stream 4, to the correspondingly high volatile suspended solids (VSS), there is a high correlation as would be expected given the high organic inputs in either the dairy or and industrial food processing plant. This is also evident in the reject stream leaving the ultra-filter, flow stream 6. There is also a discernibly higher organic loading in the rejects from the reverse osmosis as shown in FIG. 8. Therefore a rich organic feed stream, optimal as a feed source for an anaerobic digester, can be made by blending the various reject streams 29, 48, 54, and 62 with the reject stream 76 from the reverse osmosis element 72 within system 10.

For a point of clarification, the term reject is typically used when filtration or other dewatering process is applied to a stream loaded with suspended solids matter and the suspended material is extracted. System 10 while in the process of extracting suspended and dissolved solids from the target waste stream, simultaneously and in this case sequentially cleans the target waste stream. The amount of nutrient extracted and the exiting water quality is dependent on whether only Subsystem 12 is installed, or Subsystem 12 and Subsystem 14 are installed, or if all Subsystems are installed. Reject stream 20 has a solids concentration of between 12 to 20% whereas the reject streams 29, 48, 54 and 62 have solids concentrations ranging from 1% to 6% solids dependent incoming water analysis, dairy herd feed if a barn flush application, or industrial food processing plant raw ingredients. Based on the percent solids and volume associated with reject streams 29, 48, 54 or 62 it may be most economic to blend one, some or all of these reject streams with the large volume and significantly dryer dewatered solids element 20 leaving element 18 of system 10. This strategy may work well based by example on seasonal dairy herd feed rations. An alternate blending strategy may be better for another season of the year based on changing feed rations. Specifications as defined by customers for soil amenders may dictate a different combination of reject streams that yield a higher byproduct economic value.

In one embodiment system 10 provides use nutrient extraction equipment that provides for selectively adding system capacity as needed As has been detailed elsewhere, the depth filtration elements 44 and 52 as detailed on system 10 FIG. 1 are available in certain flow ranges. As was also stated, the actual flow rate of these units is dictated in part by the organic loading, TSS of the infeed streams such as 42 or 46 entering the filter elements. Therefore the design capacity of system 10 to handle a specific flow stream volume combined with the organic loading of the stream will dictate the number of units 44 and 52 that need to be installed in parallel to handle the design volume. As these units are typically installed in a manifold with multiple units installed in parallel, the original installation would be more flexible if a manifold designed to accommodate more units at later date but not installed at this time, was installed. To a lesser extent, more capital-intensive equipment such as the initial dewatering device 18, or the settling chamber (Reference FIG. 4) and embedded clarifier 26, or the dissolved aeration floatation/lamella clarifier 58 can be installed to accommodate future expansion. By example a vibrating screen element 18 with a smaller effective surface area to handle a smaller current flow rate could be Incorporated now into the project. At a future date, when increased throughput capacity is required the nonfunctional blinded off area of the screen could be replaced with the appropriate mesh screen for additional capacity. Similarly the reverse osmosis (see FIG. 7) unit element 72 could be designed and installed such that future reverse osmosis tubes could be in installed at a later date and the tubes fitted then with more membranes to increase the throughput capacity.

FIG. 8 flow stream 3 shows a greater than two times reduction in TSS after the DAF (dissolved aeration floatation reference FIG. 5) trial unit process step. The dissolved aeration floatation (DAF) process injects small air bubbles into the target waste stream. The light suspended solids with or potentially without the addition of a chemical flocculating agent, tend to agglomerate to the rising air bubbles and form a scum on the surface of the DAF unit shown as element 58 within system 10. Reference FIG. 5 which is a process flow diagram of a DAF unit. In the case of even finer suspended solids, a flocculating chemical is added which encourages the agglomeration of the fine suspended solids to the rising air bubbles. A traveling paddle system across the surface of the DAF unit moves the sludge to the discharge section of the DAF. The upstream dewatering device shown in FIG. 8 was unable to remove the finer suspended solids. The TSS as detailed by stream 1 (stream 1 and 2 were the same) into the DAF unit were dramatically altered by the performance of this unit to remove finer suspended solids, as reflected by the TSS numbers in flow stream 3 which exited the DAF unit. of FIG. 8.

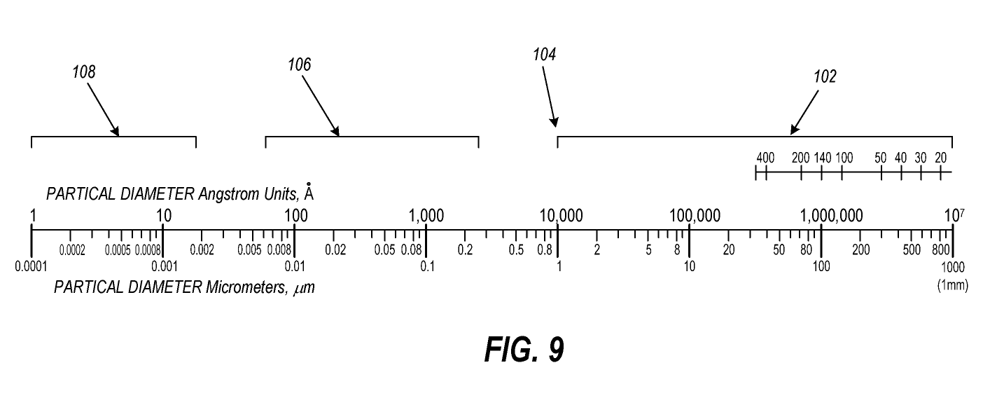

In one embodiment BOD₅ levels in flow stream 3 of FIG. 8 can range from 4000 mg/L down to less than 1000 mg/L. BOD₅ is a laboratory measurement of the propensity of the material within the waste stream to preferentially consume dissolved oxygen within the watershed for aerobic digestion. It is the small suspended solids material or the dissolved solids which most directly affect BOD₅. activity levels. It will be the lamella clarifier or equal with possible chemical addition indicated as part of element 26 within system 10 on FIG. 1 or the dissolved aeration floatation (see FIG. 5) or lamella clarifier indicated as element 58 within system 10 or the reverse osmosis (see FIG. 7) element 72 which will extract the smaller suspended solids material or dissolved solids and thereby reducing on BOD₅. Reference FIG. 9 which details the particulate filtration scale. On that FIG. 9, you will notice which membrane filtration types are best suited to process or remove different particulate sizes. By example note that the size of the sugar molecule is best handled by reverse osmosis (see FIG. 7). As the reverse osmosis can deal with the very small organic compounds which tend to aerobically digest quickly, their removal before reaching the watershed would have a positive effect on BOD₅.

Settling and depth filtration remove suspended solids and achieve corresponding reductions in TSS, VSS and BOD₅. The vibrating screen as indicated by element 18 in system 10 removes the majority of the suspended solid, by non-limiting example from the dairy barn flush waste stream. This is evidenced by the dewatered solids removed at that unit process reaching concentration levels of 12 to 20% solids. Although the 80 screen typically used on a vibrating unit is rated at 185μ, this is still the larger particulate within the dairy barn flush waste stream. See FIG. 10 for a picture of a typical unit. The smaller the particle size of the suspended solids material, the more challenging is the removal process. The settling chamber depicted by element 26 slows down the horizontal velocity of the flow stream in order that the vertical settling velocity is generally, as defined by Stoke's Law and fluid dynamics, faster thereby settling out suspended solid in the flow stream 24 FIG. 1. The embedded lamella type clarifier embedded within settling chamber (Reference FIG. 4), may use chemical flocculant to cause the suspended material to agglomerate and therefore manipulate the agglomerated material to settle out of the flow stream more readily. The suspended solids concentration in the reject stream 29 leaving element 26 can range from 1 to 6% solids. By manipulating the flow stream and the settling chamber and manipulating the apparent size and weight of suspended solids, concentrations can increase to 4 to 6%. The depth filters depicted by element 44 and element 52 can extract suspended solids such that the sludge leaving in reject streams 48 and 54 can range from 1% to 6% solids. By utilizing compressed air, as opposed to more backwash flush water, the concentrations in the reject streams can climb to 3 to 6%. It should be noted that depth filtration as shown on FIG. 1 is sequential with regards to reducing particle size. Element 44 would typically remove particulate 100μ or greater, while depth filter elements 52 may again be progressive and particulate may range from 100μ down to 50μ, with the final stage of depth filtration removing particulate from less than 50μ down to equal or less than 5μ. By means of comparison, a typical human hair is 75μ in diameter.

In one embodiment a vibrating screen can be fitted with mesh sizes ranging from 40 mesh (381 micron) to an excess of 200 mesh (75 micron). See FIG. 10 Based upon operating data, vibrating screen mesh size needs to consider the effective open area of the screen and therefore the corresponding surface area of the vibrating screen, as well as the potential for the screen to blind over or become plugged. Although 30 and 40 mesh screens have been used to dewater dairy barn flush water, better solids removal rates have been achieved and not at the expensive of more plugging potential based on using an 80 mesh screen.

The settling chamber and lamella clarifier as per FIG. 4, illustrated as element 26 on FIG. 1 for system 10, remove the smaller particle sized TSS organic matter when compared to the vibrating screen element 18. As detailed above the range of concentrated suspended solids in the reject stream 29 can be impacted by the nature of the particulate in the barn flush water resulting from the animal feed rations delivered to the dairy herd as well as whether or not any level of chemical flocculant is added at the lamella clarifier unit. the range of within this reject stream can be from 1 to 6%.

In Subsystem 14 TSS is filtered to a 5μ particulate size level. Organic based suspended solids leaving Subsystem 14 as represented by flow steam 56 FIG. 1 will have between 100 to 1000 mg/L concentration. The total suspended solids levels within flow stream 56 were higher due to a large fraction of fly ash. This was confirmed by lab analysis. It was discovered that the farm used fly ash for road and earth stabilization in the event of rain. Fine light fly ash would have been airborne and fouled the lagoon and barn flush water over time.

In one embodiment illustrated in FIG. 3 represented the on-site dairy testing configuration of the automatic backwash filters elements with air assist to minimize dilution of reject streams. These automatic back washable filters are depicted on FIG. 1 as elements 44 and 52 Test samples were taken at locations as indicated on the process flow sheet of the test configuration as shown on FIG. 3. Jar test type samples were also taken after the 2^{nd} depth filter equipped with a 5μ filter element. No visible settled solids or suspended solids in the flow leaving the filter were evident and this was also the case after the samples were left undisturbed overnight. The jar test samples were slightly opaque with a slight green-gray tint. This confirmed that no meaningful solid accumulation would occur if the flow stream 56 as per FIG. 1 were directed into the lagoon(s). Given the organic loading in the samples tested after the 5μ filter were less than 0.1 mg/L, off gassing associated with biogas from aerobic digestion of organic material directed to the lagoons would be minimal to nondetectable. The laboratory testing of the samples taken at that same location confirmed a higher value for inorganic suspended solids. As this material also passed the 5μ depth filter, it would not be predisposed to settle out. Secondly given that this material was tested to be inorganic in nature, it would make no contribution to any lagoon off gassing. Reference the lab results for the flow stream 7 discharged from the reverse osmosis shown on FIG. 8 and specifically the volatile suspended solids (VSS) result. It should be noted that if system 10 included Subsystem 16, there would be virtually no organic matter in accept stream 74 from the reverse osmosis (see FIG. 7) unit process element 72, therefore there would be no off gassing from that source. There may however be off gassing based on residual material in the lagoon that was directed their prior to installing system 10.

In one embodiment, treated waste stream discharged from system 10 is cleaned to a level where it can be land applied or reused for all but potable water purposes. Lab test results for total suspended solids, total dissolved solids, volatile suspended solids, BOD, sodium, chlorides and the nutrients, P, N and K, were generated. Please reference FIG. 8. which illustrated field testing carried out in 2012-2013. Results for stream 7 of FIG. 8 confirm water quality, for the variables sampled equal to the water quality levels established for non-restricted irrigation waters, as well as potential for watering livestock. As the testing was focused on the recovery of nutrients from waste water streams, testing for other inorganic contaminants or heavy metals was not the focus of the trial of that time. That still needs to be done to confirm the quality level of the cleaned water.

In one embodiment system 10 includes a sequential series of unit process steps to treat the waste stream from certain organic sources, including but not limited to, restaurant and organic waste and effluents from industries such as breweries, grocery stores, food processing plants, granaries, wineries, pulp and paper mills, ethanol and biodiesel plants, agricultural field crops, organic sludge accumulation within lagoons and waterways, marine organic matter and animal manure. Stage 1 Detailed as Subsystem 12 on FIG. 1 represents the initial wastewater treatment system dewatering equipment 18 as well as a combination suspended solids settling tank and integral lamella clarifier (see FIG. 4) 26 with discharge to either a surge tank or repurposed and designated lagoon 38. Incorporated into this Subsystem 12 is a chemical metering skid 28 in order to enhance the suspended solids removal performance of the lamella type clarifier and a sludge tank 32 with appropriate controls 34 and sludge handling system pump 36. There is also located after surge tank 38, a transfer pump 40 which pressurizes the accumulated intermittent flow volume and transfers downstream to 2^{nd} stage detailed as Subsystem 14 on FIG. 1.

This Subsystem 12 of the overall Nutrient Concentration and Water Recovery system 10 for more continuous waste stream flow rates from industry is not sized to handle peak flows as was the case for the intermittent barn flush activity. By non-limiting example, the markets served and listed above could result in more continuous flow rates in the subsequent downstream Subsystem 14 and Subsystem 16, identified on FIG. 1. System 10 could be sized from 5 gallons per minute to over 1000 gallons per minute based on specific applications. In addition, the suspended solids removal equipment 26 located after the vibrating screen or equivalent 18 is necessary to remove a substantial fraction of the suspended solids entering system 10. By removing between 40 to 90% of the TSS within incoming water at this point in the process maintenance associated with cleaning out either the surge tank 38 or dedicated on-site lagoon is reduced. In addition, with a large portion of the settleable solids removed at this point in the process, the waste water quality would be improved allowing for greater recycling of this water, more nutrient material extract to be used as a fertilizer substitute, or dried and sold as animal food supplement subject to testing or discharged without sewer charge penalties to the local sewer district.

Subsystem 14 on FIG. 1 represents the 2nd stage of the wastewater treatment system. Subsystem 14 includes a series of sequential automatic depth filters. Units can be equipped with progressively finer micron rated filters. Unit process 44 has an internal recirculating loop required to maintain filtration efficiencies. By cleaning the recirculated flow with centrifugal separator 50 or equivalent, recirculated organic TSS material can be continually bled away from the system thereby reducing the amount of TSS material subject to fiber breakdown due to traveling through the recirculating pump. This ensures that suspended material is removed rather than reduced in size and therefore transferred downstream to be removed by finer micron rated depth filtration. As in the Subsystem 12, there is a common sludge removal system including a sludge tank 32 with level controls 34 and the sludge discharge pump 36. Subsystem 14 is sized for a continuous flow. As final depth filtration which includes unit 52 are rated down to 5μ with actual particulate removal ranging from 5 to 3μ, any residual TSS does not pose a settling problem in any of the on-site lagoon(s) or other storage tank. Reject streams 54 and 48 due to their similar characteristics are by non-limiting example, co-mingled in the sludge tank 32. Reference FIG. 3. In addition to the laboratory analysis, an industry standard jar type test was performed on the water quality exiting the pilot test equipment represented by FIG. 3. After an overnight settling period, there was no evidence of either suspended solids or settled solids in the jar test. Based on these results, the lab results and the absolute filtration rating of units 52, very limited settling is anticipated in any of the lagoons on-site. This in turn minimizes lagoon maintenance, the potential for final lagoon liner damage associated with use of heavy sludge removal equipment, as well as minimal off gassing due to minimal TSS loading which would include minimal organic material.

Subsystem 16 as shown in FIG. 1 is the final stage of filtration, nutrient removal and water recovery in system 10. The components within this Subsystem 16 incorporate many of the pilot test components used during the on dairy farm testing in 20 Subsystem 12—2013, FIG. 8. Again as in the case of Subsystem 14 FIG. 1, the hydraulic loading for this subsystem, could range between 5 gallons a minute to 1000 gallons a minute. Based upon minimal TSS loading after the 5μ depth filter units 52, a dissolved aeration floatation unit 58 complete with flocculating chemical addition by chemical metering skid 60, would reduce TSS loading in the accept stream 66 such that the final in-line cartridge filters 68 could remove any residual suspended solids. Sludge removed from the feed stream 56 as shown in reject stream 62 would be collected in sludge tank 32 with level in the tank controlled by level control 34 which would activate sludge discharge pump 36. The water quality as per flow stream 70 FIG. 1, would be suitable as reverse osmosis (RO) feed water. The reverse osmosis (see FIG. 7) unit is included in system 10 if the final water quality leaving the system needs to be at a water quality level not restricted any EPA discharge criteria. It is expected that this water subject to further testing will be equivalent to non-potable water. The incremental benefits of the reverse osmosis system are the removal of any elevated chlorides within flow stream 70 as well as any elevated phosphorus levels. Phosphorous due to its very stable nature and slow pickup by crops is usually the nutrient that exceeds Nutrient Land Management Act levels. Because of the cost of reverse osmosis 72, a smaller reverse osmosis system not sized for the full process flow 70 may be installed. This is possible because the chloride and phosphorous levels are so reduced going through the reverse osmosis that a blended strategy with water not treated by a reverse osmosis (see FIG. 7) system can be utilized and therefore the capital cost of the overall nutrient concentration and water recovery system 10 can be reduced. By example, the cleaned product water leaving FIG. 1 Subsystem 16 element 72 could be automatically chlorinated and used as nothing more than a floor wash down water in a food processing plant. More testing would be required to determine if the FDA would accept “higher uses” of this recovered water, by non-limiting example incoming raw food wash-down.

In one embodiment system 10 improves the extraction of the desirable fertilizer components found within these waste streams, including but not limited to P-N-K. In one embodiment the system provides a nutrient concentration and water recovery process illustrated in the FIG. 1. As a non-limiting example system 10 can be used to remove suspended solids that have the potential to foul the reverse osmosis unit process step. Reverse osmosis (see FIG. 7) uses osmotic pressure across spiral wound membranes to restrict the flow of specific molecules while allowing other molecules to pass through the membrane. The depth filter units indicated as 44 and 52, by contrast capture all suspended material as they attempt to pass through the filter element. Backwashing these units drives the surface trapped material off of the depth filter such that it can regain its flux rate (flow rate per square area of filter element).

By contrast, reverse osmosis membranes cannot be back washed without doing major damage to them. Therefore reverse osmosis cannot be subjected to suspended solids. The final cartridge filters are there to provide protection. If there are high chlorine levels in the water fed to the reverse osmosis, an activated carbon filter element may be required and could be installed with the cartridge filters or as a substitute. As a non-limiting example a DAF or lamella clarifier with potential chemical flocculant addition can be used to replace a very expensive ultrafilter or centrifuge if the TSS if levels are less than 4500 mg/l. Initial water quality will confirm the need for element 58 on FIG. 1. Waste water quality combined with a more suspended solids tolerant reverse osmosis system, has potential to remove the need for element 58. The reverse osmosis (see FIG. 7), with more frequently programmed flush cycles and the use of 2 micron cartridge/bag filtering media in element(s) 68 upstream to protect from suspended solids will be used to maximize the potential of removing element 58 from system 10 FIG. 1

In one embodiment in dairy operations the selection takes into consideration density and size of the suspended particulate which in turn are dependent on the feed given to the dairy cattle and the dairy breed.

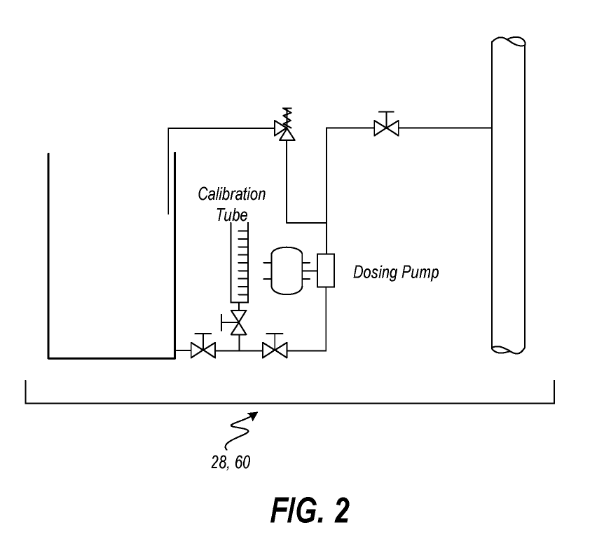

In one embodiment if chemical addition is required for system 10, automatic metering is used and requires only limited operator monitoring and intervention. FIG. 2 provides a schematic of a typical chemical metering skid. Dosing will be light and can range from 0.01 mg/L to 1 mg/L of system flow rate.

It should be noted, that FIG. 1 represents a multi sequential step process. As such the overall performance of the process is not tied to one unit process as in other waste treatment plants where by example the only treatment step is clarification. As such, continuous fine tuning of chemical metering is not as critical in the process as defined by FIG. 1.

In one embodiment system 10 can be used to recover nutrients from agricultural facilities or industrial food processing plants when the waste constituents can be organic in nature. High organic loading levels associated with food processing plants as well as abandoned lagoons, or contaminated watersheds due to the accumulation of flood damaged waterways, could use an embodiment of system 10 to extract and manage excessive organic waste contaminants. As such the recovery of these nutrients in separate and discreet waste streams and their reapplication to land as fertilizers without toxic implications is achieved because the concentrated reject streams can be controlled and diluted to target values which do not exceed Nutrient Land Management Act levels. Any concentrated nutrients within the reject streams in excess of the amounts required to comply with the Nutrient Land Management Act for the onsite farm applications can, can be shipped to off farm to locations where they can be sold as organic soil amenders and/or substituted for chemically based fertilizers. In one embodiment the raw material treated has only organic contaminants sourced from agricultural and/or industrial food processing waste streams. By removing these organic suspended or dissolved components the aqueous portion of the waste stream can be cleaned up such that it can be discharged either on the fields or into watersheds without harm.

In one embodiment heavy metal contaminants present are removed at the reverse osmosis (see FIG. 7) unit process step. Reverse osmosis thin film membranes, typically used in wastewater treatment require relatively low inlet feed pressure to perform. They are able to selectively remove certain nutrients such as nitrogen, phosphates and potassium as well as some heavy metals and contaminants. The presence of contaminates such as lead, or mercury may also be found at some sites. Other contaminates may also be dissolved in the water and therefore in the waste water stream. Water analysis is required before system technology is applied. Because the selection process is dissolved molecule size dependent, both nutrients and contaminants may be co-mingled in the reject stream, thereby rendering the nutrient value of the reject stream nothing. By non-limiting example the appropriate membranes for nutrient recovery would remove 95 to 98% of the phosphates and 92 to 96% of the potassium. However the same membrane may reject or concentrate 95 to 98% of the lead as well as 94 to 97% of the mercury.

In one embodiment if the waste stream is contaminated with only suspended and dissolved solids that are organic in nature, such as barn flush water, anaerobic digester digestate, or industrial food processing waste water, the nutrient concentration and water recovery process is applied. The methods within system to avoid diluting the reject streams and therefore concentrating the organic and nutrient values in Subsystem 12, Subsystem 14, and Subsystem 16 have been discussed above.

In one embodiment waste streams, including those for industrial and food processing plants, can differ based on regional water quality, type of agricultural waste; hog or dairy, as well as the seasonal variations in agricultural feed ingredients. Although all chemicals added during processing and used in industrial food processing plants must meet FDA requirements, there can be variability from food processing plant to food processing plant as well as from production line to production line. This can cause changes in percentages of suspended solids, particle size distribution, and percentages of dissolved solids and the relative volumes and concentrations of the dissolved material. All of these things can change the required flow rates in the various unit process steps, the recovery percentages of each unit process, and therefore the sizes of the various unit process equipment. Suspended solids from a food processing plant which handles potatoes could have TSS levels of 5 to 25,000 mg/L. Particulate size can range from small starches near 5 micron up to particulate at 400 to 500μ. Total dissolved solids in such a process can approach 5000 10,000 mg/L. These ranges would by non-limiting example also be subject to whether food processing plant fresh or frozen finished products. Waste water analysis as a first step is critical.

In one embodiment system 10 is used for 3 sequential stages to recover all available nutrients and reclaim water within the waste stream to the highest quality (least contaminated) level. In one embodiment each of these stages has multiple unit process steps incorporated.

In one embodiment system 10 as depicted in FIG. 1 uses three sequential stages referred to as Subsystem 12, Subsystem 14, and Subsystem 16. The focus of the first subsystem is to remove the larger suspended solids. In the case of high but intermittent flow rates such flow streams 24 as in the case of CAFO barn flush, components are sized to handle maximum flow rates associated with the periodic but non continuous flows. As a non-limiting example dairy barn flush flows can be up to 1500 US gallons per minute based on normal flush practices on a three thousand head dairy. As a non-limiting example the flow rate can extend over a one hour period. To better use capital investments, subsystem 1 is designed for this flow rate prior to accumulation with either a surge tank and/or an onsite lagoon recommissioned as a cleaner liquid storage lagoon. As a non-limiting example the volumetric capacity of the surge tank or “repurposed” lagoon can be 90000 gallons. This allows for the reduced sizing of the unit process steps/equipment represented in sub systems Subsystem 14 and Subsystem 16. The intervening time between barn flushes can be used to spread the time over which the contents of the storage lagoon can be processed. This by no limiting example reduces the process flow capacity of the subsequent unit process steps downstream from 1500 gallons per minute to 180 gallons per minute.

In one embodiment unit process 26 in in Subsystem 12 as depicted in FIG. 1 can include a pre settling chamber with modified features to drop out the larger settleable solids. In one embodiment waste water analysis is required to determine if an incremental step such as an imbedded lamella clarifier (see FIG. 4) is needed to reduce suspended solids to a level where suspended solids accumulation in either the downstream surge tank or the repurposed clean lagoon is minimized. In this way, heavy equipment is not required for solids removal and infrequent wash down to drain and pump out is feasible alternative. In one embodiment unit process 26 can be installed as a settling chamber only.

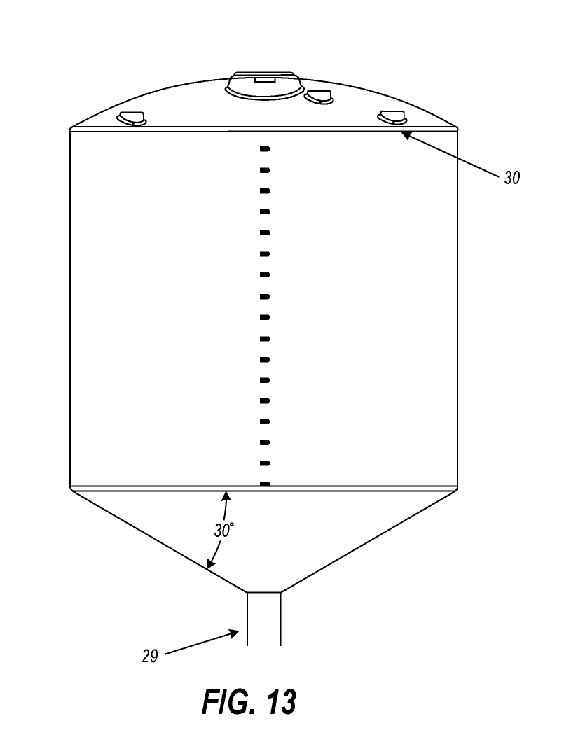

In one embodiment by installing the dewatering device process unit 18 as shown in FIG. 1 upstream of and above a large closed top poly tank see FIG. 13 positioned inside either the surge tank or designated lagoon and placed horizontally, retention time and settling suspended solids velocities can be used to remove a large fraction of the settleable TSS before the TSS laden waste water is allowed to deposit the suspended solids into either the surge tank or the designated onsite lagoon. Based on specific TSS conditions, this novel configuration could avoid the capital cost of flow element 26 as shown on FIG. 1 and detailed in FIG. 4. By fitting this tank with positive displacement pump(s), accumulated settled solids can be removed from this “stilling chamber” and handled as flow stream 29 in FIG. 1. The primary flow from the upstream device 18 FIG. 1 would first flow into this poly tank for settleable solids removal prior to overflow into the surge tank 38 or equivalent. In the case of a barn flush, a low level sensor signal in the surge tank 38 would also indicate completion of the barn flush and control operating time periods for the positive displacement pump(s) timer based operation while ensuring contained settled solids are not discharged to the surge tank 38. Depending on raw water characteristics, this tank-in-a-tank process design would minimize long term solids accumulation in the surge tank and permit use of other than heavy machinery as detailed above for periodic cleaning of surge tank 38 or equivalent. In addition it would represent a low cost alternative to the fractionation settling tank (see FIG. 4) assembly 26.

As a non-limiting example If there is a need for an incremental step to reduce suspended solids accumulation in either the downstream surge tank or the repurposed clean lagoon to meet acceptable settled solids accumulations in the surge tank 38, then an imbedded lamella clarifier could be added. Lamella clarifiers achieve a large and effective surface area. This permits installing the lamella clarifier into a small footprint within the settling chamber 26. As a non-limiting example, limited chemical addition may be required to extend the clarifier effectiveness to smaller and less dense suspended solids. It is intended to reduce suspended solids concentrations in flow stream 30 to less than 1%.

In one embodiment Subsystem 14 includes unit process steps 44 and 52. Each of these sequential filtration steps is progressive. In one embodiment there are initially 3 levels of depth filtration: starting with the largest particulate size ranging from 200μ down to 50μ and the 2^{nd} progressive stage stepping down from 100μ down to 20μ and the final stage ranging from 50μ micron down to 5μ particle size filtration. Each of these filtration steps has multiple units operating in parallel. As such, parallel units are installed for capacity, but also yield redundancy and therefore more process uptime.

In one embodiment sequential filtration steps in unit process 52 utilize the same filter body housings. System 10 can utilize different particulate filter sizes. The filter elements include 400μ, 200μ, 100μ, 50μ and progressively down to 5μ. A change in filter size can impact the flow capacity of the filter element and therefore the filter assembly and potentially the number of filters installed in parallel. As the filter body assemblies are the same and only the internal filter elements change, it is possible to make process changes during operation. This provides great flexibility to respond to changes in the waste water being treated.

In one embodiment, the sequential filtration steps in unit process 44 and 52 improve their respective backwash functions in a number of ways: (i) as the back wash per unit process is initiated based on a pressure differential signal measured across the depth filter, the monitoring and cleaning function is automatic; (ii) As the differential pressure signal can be adjusted, the frequency of backwash can be adjusted to compensate for a change in the waste water characteristics. It can also be adjusted if a greater buildup of suspended solids on the depth filter yields a lower TSS discharge water quality.

In one embodiment, the sequential filtration steps in unit process 44 and 52 use compressed air to assist in the backwash function. This is beneficial to the process. By using compressed air, less water is used in the backwash function and consequently the reject stream is less dilute. Transportation costs are reduced. As a non-limiting example all reject streams are discharged to small interim poly storage tanks element 32 FIG. 1. The tanks are closed top but not pressurized. Level control as illustrated by element 34 FIG. 1 is provided for both remote monitoring as well as to signal tanker vehicle to pickup of contents.

By discharging rejects into interim closed top rejects storage tanks element 32, much of the nitrogen is retained. Given nitrogen's tendency to disperse into the atmosphere as a gas and dissolve into the water, the nitrogen captured in the TSS that has been removed from the waste stream, and stored in the closed storage tank will off gas from the TSS sludge until a partial pressure above sludge reaches equilibrium as per Dalton's Law of partial pressures. With limited air circulation into the storage tanks, beyond pressure relief vents, the nitrogen gas will stay in the tank and therefore slow/reduce the further off gassing of the nitrogen rich sludge.

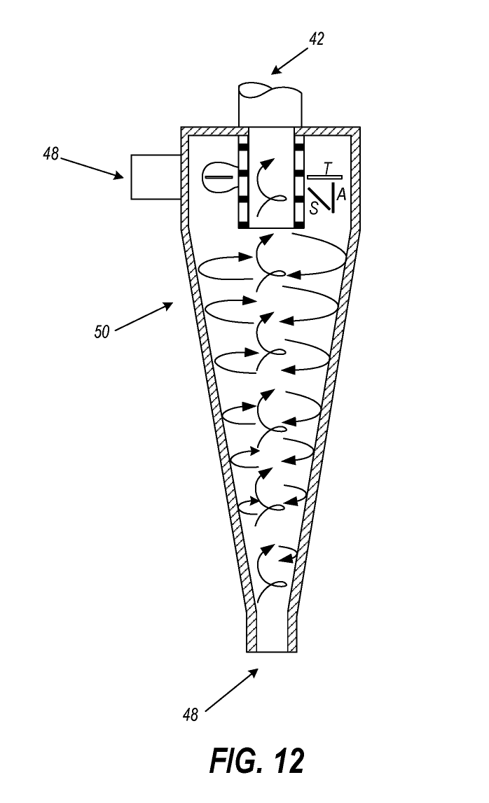

In one embodiment unit process 44 is equipped with a centrifugal separator element 50 FIG. 1. See FIG. 12. This unit is added to remove TSS recirculated, which is required to maintain flow rates across the filter elements. In addition, by removing the TSS prior to recirculation, any particle damage or size reduction associated with going through the recirculation pump is minimized. The centrifugal separator element 50 within Subsystem 14 on FIG. 1 shows the relative position of this device within the recirculating loop around depth filtration element 44. A chambered valve configuration dumps accumulated solids without continuous liquid discharge and subsequent rejected TSS dilution.

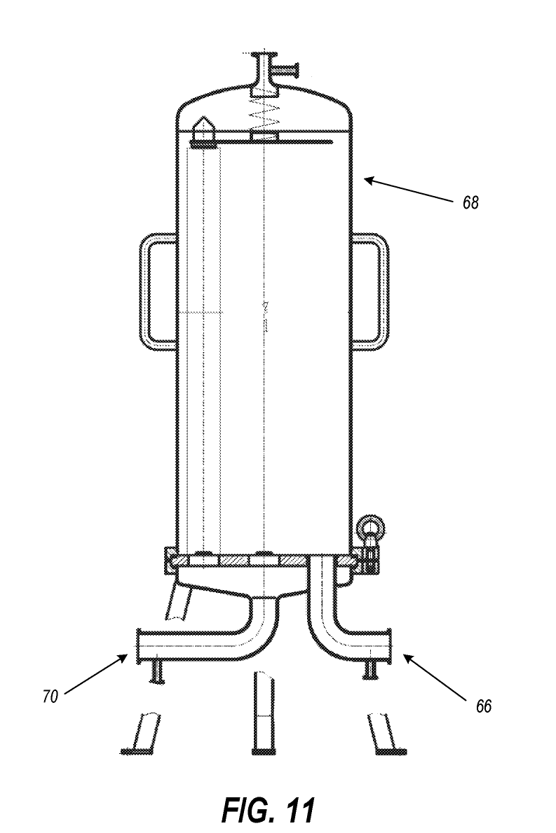

In one embodiment, Subsystem 16 can include unit process steps 58, 68 and 72. Subsystem 16 is included in the overall process in order to remove all residual TSS such that reverse osmosis (see FIG. 7) can be used to extract the remaining nutrients and the phosphorus and chlorides which due to their presence may otherwise limit “unrestricted discharge” of the final water stream 74 as depicted on FIG. 1. As flow stream 56 as shown in FIG. 1 can be filtered such that any remaining TSS is less than 5 micron, residual TSS will require alternative removal methods. In Subsystem 16, each of these sequential remediation steps is progressive. In one embodiment there are initially 3 levels of cleaning. As the TSS loading levels in this flow stream 56, are still too high to use inline cartridge filters (see FIG. 11) at this point, other options include centrifuges, ultrafiltration, clarification or dissolved aeration floatation (see FIG. 5). In one embodiment clarification or dissolved aeration floatation can be utilized. As a non-limiting example, water analysis of flow stream 56 can be used to determine which the better option is. Given the small particle size distribution in flow stream 56, a small dosing of flocculant may be required. Dosing levels ranging from 0.01 to 1.0 mg/l may be required. As the dosing is performed by an automatic metering system, and given the FDA compliant chemical costs are minimal for the anticipated dosing, the increased operating costs do not offset the increased capital costs of other options such as the costly centrifuge or ultrafilter.

In one embodiment the rejects from unit process 58 can be handled in the same way as in Subsystem 14. By discharging rejects into an interim closed top rejects storage tank, much of the nitrogen is retained. Given nitrogen's tendency to disperse into the atmosphere as a gas and dissolve into the water, the nitrogen captured in the TSS removed, and stored in the closed storage tank will off gas from the TSS sludge until a partial pressure above sludge reaches equilibrium as per Dalton's Law of partial pressures. With limited air flow into the storage tanks, beyond pressure relief, the nitrogen gas will stay in the tank and slow/reduce the further off gassing of the nitrogen rich sludge.

In one embodiment inline cartridge or bag filter units can be utilized after unit process 58. There will be multiple units installed in parallel to permit manual change out of cartridge filters when they have signaled a change out of bag filter due to exceeding the differential pressure set point and subsequently triggering an alarm. In one embodiment to ensure system uptime, given the complete system is not staffed 24 hours per day, additional parallel units will be installed? In one embodiment light TSS loading leaving unit process 58 can result in cartridge filters acting as emergency process protection for the downstream reverse osmosis (see FIG. 7). In one embodiment a final TSS in flow stream 70 as per FIG. 1 can be <1 ppm. In one embodiment bag filter replacement does not generate a sludge type reject flow from this 68 unit process. Bag filters within the bag/cartridge filter housings are typically removed and replaced.

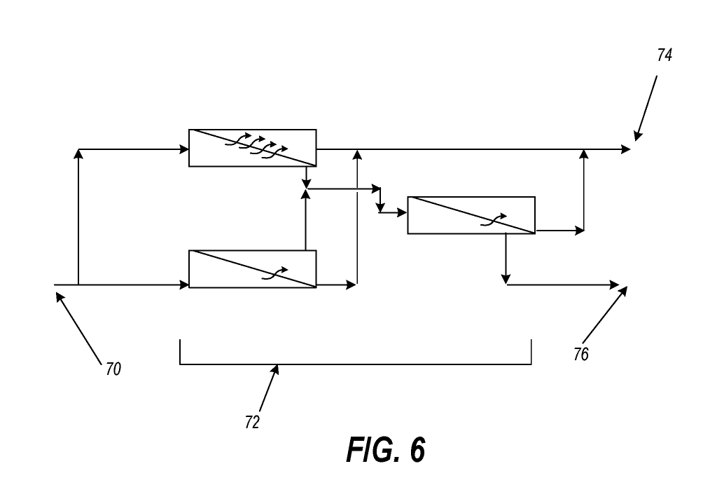

In one embodiment the next unit process in Subsystem 16 is 72, the reverse osmosis (RO) process. In one embodiment a 2 stage reverse osmosis configuration can be utilized as shown in FIG. 6 and can maintain a high recovery rate without excessive pressure drop. Avoiding the high pressure drop would reduce the connected horsepower required to run the boost pump feeding the reverse osmosis element 72. By comparison thin film membranes used in RO used to require 150 psi supply pressure. It is anticipated that with good design, the in feed into the system would be less than 100 PSI. In one embodiment based on infeed water analysis, an automatic anti-scaling chemical dosing skid can be used. There are no suspended solids in the reverse osmosis reject stream designated 76. This flow stream with a virtual absence of suspended solids can be treated as a liquid. It can be collected and used with irrigation/syphon systems dependent upon the dairy farmer's best and highest use for this material. It can also be combined with all the other reject streams 29, 48, 54, and 62 to become a concentrated nutrient stream for sale or use as an on farm fertilizer alternative.

In one embodiment when the chloride and sodium concentrations in a flow stream 76 are high, their removal is required. Reference FIG. 8 flow stream 8. Without removal, the other nutrients may not be available for land fertilizing. A small incremental reverse osmosis unit built into the primary RO as part of the reject stream 76 would be sized and designed for the smaller reject stream leaving the primary osmosis. This would be a variation on the RO configurations shown on FIG. 6. This unit would only be used to reduce contaminates listed above to levels acceptable for land application.

In one embodiment the overall process flow capacity of Subsystem 16 may not match that of the previous two stages. On a per gallon basis, water treated in stage 3 is the most costly. Based on site conditions, the demand for this level of clean water may be limited. As a non-limiting example, further testing is needed to determine if the FDA will accept this water quality to displace CIP (clean in place) water used in the milk parlor. In addition this clean water can be used to dilute the chemical buildup in the recycled barn flush water. If barn flush water is treated to a Subsystem 14 level by example, TSS has been significantly reduced to allow for barn flush, but each reuse will accumulate the level of dissolved chemicals. In one embodiment some cleaned Subsystem 16 discharge water designated as 74 water may be used to dilute and extend the number of reuse cycles such as barn flush water. Subsystem 16 cleaned water quality will be site specific as indicated by analysis of source water.

FIG. 9 illustrates an embodiment of particle sizes which can be a removed by the most effective filtration/membrane technology. System 10 can include dissolved and suspended solids. In one embodiment system 10 can execute a number of process steps to precondition target material. In one embodiment it is possible to specifically pick process technology targeted for each of the size range classifications of particulate in the waste stream in question. The process as generally depicted in FIG. 1 and represents this system approach. All unit process components are selected and placed within the overall process. In one embodiment the following criteria are used for the selection of unit process steps shown in FIG. 1:

(i) largest suspended solids removal first and the removal of process equipment damaging inorganics including sand;
(ii) consider all EPA related constraints and design process to achieve overall compliance
(iii) with selective particle size filtration, minimize or avoid the need for solids accumulation in the process that would require periodic cleanup;
(iv) reuse of site facilities including installed dewatering equipment and substitution of a designated existing lagoon for a surge tank;
(v) the overall process can have any number of subsystems depending on acceptable project paybacks and overall affordability;
(vi) a high concentration of reject streams can be used to expand reuse options such as adding to the primary dewatering solids pile without increasing liquid fractions to the point where trucking becomes environmentally complicated;
(vii) a high concentration of reject streams can be used to increase by-product value;
(viii) automated unit processes can be used, including but not limited to automatic backwashing of depth filter unit processes, to reduce operator intervention and costs;
(ix) multiple sequential unit process steps can be consolidated into less or more cost effective process steps; and,
(x) more progressive and advanced technology can be used.

As a non-limiting example pumping waste material requires some specific design features in the piping associated with transferring the flows with higher solids content, as well as the lines handling higher urea concentrations. In the case where higher solids content flows stop and start, there is a high potential for settling of solids out of the flow stream and consequential line plugging. A low point drain feature as well as “cleanout flush elbows” represent effective handling strategies. Their location(s) as well as the number can be dependent upon the concentrations of the fluids handled and other site-specifics.

In one embodiment further incremental design requirements can be based at locations of high urea. In one embodiment non-rigid piping such as pressure rated flexible tubing or hoses can be used in order to minimize the precipitation of struvite. (NH4)MgPO4.6(H2O) and a molecular weight of 245.41 gm can drop (precipitate) out of solution and crystallize on rigid wall structures associated with the piping system. The precipitation of struvite can result in crystalline structures forming within the inside of rigid and fixed equipment such as pipelines etc. If left unmanaged, this material will over time restrict and ultimately plug some of the pipelines rendering the system inoperable.

In order to avoid operating problems associated with pipeline plugging, include all the following piping design strategies and process operating conditions in the design of skid piping and interconnections between unit process steps: maintain liquid velocities, control pH levels, avoid low turbulence piping designs and install replaceable elbow sections in areas subject to high abrasion from inorganics such as sand. In addition it should be noted that gravity discharge from one unit process to the next minimizes piping related operational problems and system plugging which in turn reduces unintended downtime.

As a non-limiting example, level sensors as depicted by element 34 FIG. 1 can be utilized with a system controller such as a PLC (central programmable logic controller), and can log the number of fill cycles and therefore totalize each of the discreet reject streams. This may be necessary for inventory and subsequent sales of this nutrient rich material. Depending on the consistency of these reject streams; positive displacement type discharge pumps would be suitable. These same level sensors could alarm at a certain defined level in order to initiate tanker type truck pickup of the contents. In addition, these sensors would also control the off on function of the discharge pumps. In a similar way, the automatic backwash feature associated with the sequential depth filters in Subsystem 14 FIG. 1, could be tied into the same PLC to log both number of backwash events as well as time duration between events. This data could be used as a surrogate for either the overall condition of that specific depth filter assembly, or to indicate that something upstream has occurred such that downstream loading at the filters has changed and should be investigated. This same PLC could monitor the level of chemical at the chemical dosing unit for: the antiscaling for the reverse osmosis (see FIG. 7), chemical injection if required at the dissolved aeration floatation (see FIG. 5) element 58, or the lamella clarifier unit 26.

In one embodiment anti-scaling chemical volume can at the reverse osmosis, 72 and be monitored with a subsequent signal for the need to replenish. The same PLC as referenced above can log the run hours of the system and indicate the time for scheduled maintenance as well by example, the time to chemically clean the reverse osmosis membranes. As a non-limiting example, the PLC can be programmed to start up and shut down the system in the correct order. Shutting down 72 before previous unit process steps 44, 52, 58, and 68 can cause equipment damage and create a mess in terms of unintended spills. In one embodiment system 10 components can be cleaned with an automated spray shower at certain predetermined intervals and especially at the beginning of shut down periods.

In one embodiment the PLC can be programmed and configured to log operating data remotely as well as auto dial for operator intervention as and when required.

As a non-limiting example system 10 can be used for pumping out existing lagoons and treating the waste stream that is discharged. In addition this technology could be used to handle the cleaning of various operating tanks at municipal waste plants (POTW) prior to scheduled maintenance by effectively using the portable process as a bypass. In addition, it could be used to clean out fish hatchery facilities. This could also extend to lagoons at pulp and paper facilities and provide temporary process bypass to do maintenance at large septic systems associated with institutions.

As a non-limiting example pumping out of lagoons is required as scheduled maintenance and is done prior to removing solids accumulated at the bottom of the targeted lagoon(s) on an annual or biannual basis. System permits the pumping out of existing lagoons and the discharge of the cleaned water for use as irrigation, barn flush water, other CIP process, or potentially for watering livestock. As the recovered water is compliant with watershed discharge the lagoon can be emptied without having to create another lagoon to take the discharge from the first. This then allows for the concentration of the nutrients that are in each of the specific and progressive unit process steps. This material can then be applied in a targeted manner to specific fields either on or off the farm in a manner consistent with The Nutrient Land Management Act. In one embodiment system 10 can be used a trailer scaled system capable of being moved in order to provide remediation to seasonal lagoon operations, or remediation/cleanup of abandoned facilities, and the like.

As a non-limiting example in the case of industrial food processing plant plants which are processing organic material, much of the solids in the discharge stream can be extracted by elements including but not limiting to vibrating screen or other dewatering alternative located at the plant's discharge to a local sewer facility. This extracted material may be sold for animal feed. The value gained by the processing plant in selling the dewatered material is typically dependent on the volume of material produced, the quality of the material produced, the shipping distance required to take the material to the final location, as well as the number of other processing plants generating material that will ultimately be in competition if supply is greater than demand.

IAs a non-limiting example system 10 can be used to treat continuous waste streams as generated by food processing plants, breweries or other waste generating processes. In some cases it may be necessary to install a surge tank at the start of the nutrient concentration process to level out variations in infeed flow rates associated with batch processes. In one embodiment unit process step 26 can have significant value when applied as conditioned infeed for different anaerobic digester processes, lagoon draining for maintenance purposes, industrial food processing waste streams or barn flush, and the like. As a non-limiting example a surge component of system 10 reduces sizing the downstream components for the maximum instantaneous flow rate(s) and supports the use of the most cost effective and properly sized nutrient process system for the waste stream in question.

In one embodiment system 10 is capable of handling an incoming liquid waste stream contaminated with less than 50,000 ppm (parts per million) of solid material, excluding dissolved material. The dissolved solids in the filtrate in this stream may be up to 1.5%. The rest of the solids content is in suspended solids form. Total solids removal performed by the dewatering equipment such as a vibrating screen, or alternative drum screen and press varies depends on the influent characteristics and particle size distribution. Removal efficiencies can range up to 50% or higher for total suspended solids (TSS) with dewatered streams up to 15 to 20% total solids (TSS) in the reject stream when not using a screw press. Use of an additional screw press to further dewater solids from unit process 18 can achieve 30+% TS. A large fraction of the P and N nutrients in the flow stream 24 leaving the dewatering equipment remain with the filtrate (liquid stream). The remainder of the nutrients will have attached themselves and left with the dewatered solids.

As a non-limiting example there are different ways to perform the initial dewatering process. As referenced earlier, a vibrating screen fitted with a timer actuated spray shower for periodic wash down would be a typical piece of equipment. Any spray shower water would use recovered waste water with a TSS particulate size of <5 micron to avoid spray nozzle plugging as well as avoid additional waste water generation. This water could be taken from flow stream 56 FIG. 1. There are many combinations of drum screens, inclined parabolic wedge wire type dewatering screens, as well as twin wire devices. In addition there are number of different presses available. Selection is based upon performance, reliability and cost.

As a non-limiting example there are many different uses for the varying qualities of water (dependent upon the concentrations of nutrients and/or contaminants) generated from this process. The overall economics combine the capital and operating costs with the operational savings are dependent upon an overall incoming waste water volumes and quality. Only by being able to clearly characterize each of the flow streams, as well as the technology required (and the corresponding capital and operational costs) can the capital cost be minimized and the operational savings maximized. A key point to emphasize here is that the system economics is tied to the best treatment practices for each unit process as the flow cascades through these various unit process steps.

In one embodiment the system infeed material must be maintained at a temperature above 34° F. and below 115° F. for the nutrient concentration and water recovery system.

As mentioned above, the infeed material must not exceed 50,000 ppm of suspended solids material. If the concentration is greater than that, an incremental solids reduction unit process step would be required prior to feeding into the Nutrient Concentration and Water Recovery Process. Depending on the suspended solids loading greater than 50,000 ppm, additional solids removal strategies can be added. Selecting the most cost effective option would be dependent on the infeed material flow rate and the suspended solids loading rate in excess of 50,000 ppm. In one embodiment divert valves can be used before unit processes 26, 38, 58, and 68. These divert valves element 78 FIG. 1 would permit unscheduled maintenance in some cases while still being able to partially clean/remediate waste water. As initially sized for a periodic waste water flow of 240,000 to 280,000 gallons per day, certain unit process steps achieve the steady state continuous flow rates of @ 180 gpm by adding the necessary unit process modules in parallel. Therefore a shutdown by one module does not shut down or take off line that functional unit process waste water treatment. Other divert or bypass valve systems would be added based on specific applications and installations. As proposed here, is not intended to be limiting. As a non-limiting example a desirable pH of the incoming material are in the range of 6.0 to 8.5 pH (without the addition of chemical injection to adjust pH to that range). More neutral pH conditions extend the equipment operating life, reduce EPA noncompliance issues, and potentially mitigate chemical usage either for neutralizing and/or flocculation additives. In one embodiment the surge tank 38 or designated lagoon can be used for waste stream cooling if installed after a thermophilic anaerobic digester to reduce the stream flow temperature to within the range stated above. This may be necessary as the system infeed material must be maintained at a temperature below 115° F.

As a non-limiting example one function of the combined unit process step identified as 26 on FIG. 1 is the removal of suspended solids. As a non-limiting example this can be a two stage unit process step. The reject concentrated suspended solids from each of various stages can be combined, or separated. Dissolved solids are also removed in this step, primarily due to the fact that some of the dissolved solids material is attached or agglomerated to the suspended solids which are removed by this process step.

The element 26 is both a fractionation/settling tank and a lamella clarifier. The fractionation tank and a lamella clarifier are co-located within the same tank.

In one embodiment element 26 of system 10 executes a two-stage unit process step. The first function is a settling chamber to drop out larger suspended solids. The second function in this unit process step is a high-efficiency clarifier intended to focus on removing the smaller suspended solids.

In one embodiment flow into the fractionation tank is designed for the peak flow condition which is by example once every 8 hours for a one hour duration. When handling high volume but intermittent flows, System 10 is design to achieve a slow infeed flow rate, typically referred to as the flux rate and expressed in terms gpm/per square foot of cross-sectional area (of the fractionation tank) in order to settle out suspended solids. Based on fluid dynamics, the slower the flow rate the smaller the particulate size removed. The greater the difference between the settling or downward flow rate of the particulate when compared to the flux rate of the flow stream across the fractionation tank, the more effective the particulate removal is and the smaller the particulate material size removed can be. All of the above process parameters are evaluated in order to minimize or avoid all together the use of chemicals to assist in the precipitation of the suspended material within the flow stream at the lamella in element 26.

The rejects from 26 are combined and discharged. In one embodiment there can be multiple destinations for this flow stream. The reject (thickened sludge) stream 29 from this second unit process can be directed to a number of locations dependent upon the operating facility in which the nutrient concentrator system has been installed. If the nutrient concentration system has been installed after a digester, the rejects sludge stream can be redirected to the front end of the anaerobic digester, given it may be rich in volatile organic solids which have not been broken down by the first pass through the upstream anaerobic digester. If the material is found not to be rich in volatile organic solids, or if there is no upstream digester process, the material can be directed and combined with the rejects (FIG. 1-dewatered solids) from the vibrating screen or other dewatering device detailed as flow stream 20 for potential onsite composting by others. Given the relatively smaller volume of 29 reject stream FIG. 1, it can be blended with the rejects, element 20 of the vibrating screen 18 by example without an appreciable reduction in the percent solids of the dewatered rejects. This is important as maintaining a certain minimum percent solids target will avoid difficulties associated with a watery waste when handling, trucking, spreading, applying or disposing of the material.

As a non-limiting example the volume of flow stream 29 is dependent on the recovery performance of the unit process 26. Recovery is defined as the fraction of the material that flows out in flow stream 30 compared to the infeed flow stream 24. Recovery rates ranging from 75% to 98% are achievable with this technology and will greatly affect the flow rate of the rejects stream 29.

As a non-limiting example the targeted suspended solids level in the discharge, FIG. 1-flow stream 30 of this unit process step can range from 2000 to 8000 ppm suspended solids from unit process 26. As a non-limiting example this can be dependent on the particle size distribution in the incoming waste stream.

As a non-limiting example depending on the nature of the waste stream in question, that levels of suspended solids remaining in flow stream 30 FIG. 1 may be below the 2000 to 8000 ppm stated above. Lower TSS levels for 1000 to 2000 ppm may be achieved. As a non-limiting example removal levels of this magnitude may be achieved with minimal or no flocculant or chemical dosing. The requirement for dosing can be confirmed on a case-by-case basis. By removing the need for costly chemical treatment, the ongoing operating costs and therefore the payback potential for the system is enhanced. Operator maintenance is also reduced if chemical injection is not required.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Particularly, while the concept “component” is used in the embodiments of the systems and methods described above, it will be evident that such concept can be interchangeably used with equivalent concepts such as, class, method, type, interface, module, object model, and other suitable concepts. Embodiments were chosen and described in order to best describe the principles of the invention and its practical application, thereby enabling others skilled in the relevant art to understand the claimed subject matter, the various embodiments and with various modifications that are suited to the particular use contemplated.

1. A nutrient concentration and water recovery system, comprising:
an initial waste water dewatering tank configured to receive waste water and producing a waste stream; and
a suspended solids settling tank with an integral lamella clarifier configured to produce a discharge to a surge tank or repurposed.

2. The system of claim 1, wherein a clean water component from a waste stream is created.

3. The system of claim 1, wherein selected organics are retained.

4. The system of claim 1, wherein selected organics are retained and concentrated.

5. The system of claim 1, wherein selected organics are retained and concentrated in suspended solids.

6. The system of claim 1, wherein selected organics in suspended solids dissolved solids states are retained and concentrated.

7. The system of claim 1, wherein an organics level is maximized.

8. The system of claim 3, wherein the organics are volatile organics.

9. The system of claim 1, wherein the system includes 3 stages and at least one unit processes at each of a stage.

10. The system of claim 1, further comprising:
a chemical metering skid configured to enhance suspended solid removal.

11. The system of claim 1, further comprising:
a sludge tank.

12. The system of claim 11, further comprising:
a sludge pump.

13. The system of claim 9, further comprising:
a transfer pump.

14. The system of claim 13, wherein the transfer pump is configured to pressurize an accumulated intermittent flow volume and transfer the waste stream to a second stage.
